(19) United States
(12) Patent Application Publication
(10) Pub. No.: US 2003/0124966 A1
(43) Pub. Date: Jul. 3, 2003

(54) Coin sorting apparatus

(76) Inventors: Yushi Hino, Himeji-Shi (JP); Masaharu Tochio, Himeji-Shi (JP); Daisuke Hoshino, Himeji-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/329,400

(22) Filed: Dec. 27, 2002

(30) Foreign Application Priority Data
Dec. 27, 2001 (JP) 2001-397502

(51) Int. Cl. G07D 3/00

(52) U.S. Cl. 453/14

(57) ABSTRACT

The present invention relates to a coin sorting apparatus comprising a stationary member, and a rotary disk supported for rotation and disposed under the stationary member contiguously with a lower surface of the stationary member. The coin sorting apparatus is constructed such that coins slide along the lower surface of the stationary member as the rotary disk rotates and that the sliding coins are guided in a coin passage. The apparatus is adapted to receive coins including a deformed coin bent such that a convex side thereof faces the lower surface of the stationary member. The coin passage has a recessed-profile configured to accommodate the convex side of the deformed coin to ensure an engagement of an outer edge of the deformed coin with a radial inner edge portion of the coin passage.

### BACKGROUND OF THE INVENTION

1. Field of the Invention

The present invention relates to a coin sorting apparatus comprising a stationary member and a rotary disk disposed under the stationary member contiguously with a lower surface thereof. The coin sorting apparatus is constructed such that coins sliding along the lower surface of the stationary member are sorted according to the diameters thereof as the rotary disk rotates.

2. Description of the Related Art

FIG. 13 shows a coin sorting apparatus disclosed in the applicant's Japanese patent application No. 2001-79206 filed on Mar. 19, 2001. In FIG. 13, the coin sorting apparatus comprises a stationary disk (stationary member) 101 and a rotary disk 2 disposed under the stationary disk 101 contiguously with a lower surface thereof. The rotary disk 2 comprises a disk body 22 supported for rotation on a shaft 20, a resilient member 24 attached to an upper surface of the disk body 22.

An inlet opening 1a is formed in a central part of the stationary disk 101. The coin sorting apparatus is formed such that a coin fed through the inlet opening 1a of the stationary disk 101 slides along the lower surface 1b (FIG. 14) of the stationary disk 101 as the rotary disk 2 rotates. A guide structure is formed in the stationary disk 101 for selectively guiding coins sliding along the lower surface 1b of the stationary disk 101, according to the diameters of the coins.

As shown in FIG. 14, the guide structure comprises a coin passage 110 formed concavely in the lower surface 1b of the stationary disk 101. The coin passage 110 extends counterclockwise as viewed in FIG. 14 in a meandering spiral from the inlet opening 1a toward the periphery of the stationary disk 101. The coin passage 110 has, arranged from the inlet opening 1a toward the periphery of the stationary disk 101, a large-coin passage section 110a, a medium-coin passage section 110b and a small-coin passage section 110c. The large-coin passage section 110a has a width that permit the passage of large, medium and small coins. The medium-coin passage section 110b has a width L1 that permits the passage of only medium and small coins. The small-coin passage section 110c has a width L2 that permits the passage of only small coins.

The large-coin passage section 110a has a coin entrance 11 facing the inlet opening 1a, and stairs 112a and 112b formed at an interval on the downstream side with respect to the coin entrance 11. The stairs 112a and 112b are formed to reduce the thickness of the gap between the resilient member 24 of the rotary disk 2 (FIG. 13) and the large-coin passage section 110a stepwise toward the downstream side thereof. By virtue of the stairs 112a and 112b, overlapping coins are separated from each other to ensure that coins do not overlap each other and move in a single file in the coin passage 110.

A coin returning part 113 is formed contiguously with an inlet opening 1a on the downstream side with respect to the stairs 112a and 112b. There is a possibility that a pair of overlapping coins pass the stairs 112a and 112b without being separated from each other. The overlapping coins include an “upper coin” that is contiguous with the stationary disk 101 and a “lower coin” that is contiguous with the rotary disk 2. Thus, the coin returning part 113 is configured to return the “lower coin” toward the inlet opening 1a.

Since the large-coin passage section 110a extends spirally away from the center toward the circumference of the stationary disk 101, it is intended that the outer edges of all the coins moving therein should engage a radial inner edge portion 110i-a thereof.

A large-coin sorting guide 115a is disposed radially outside the medium-coin passage section 10b to guide only the large coins selectively and to eject the large coins in a substantially tangential direction. The large-coin sorting guide 115a has a step 116a and an ejecting passage 117a. The step 116a is formed at a boundary between the large-coin passage section 110a and the medium-coin passage section 10b. The step 116a is formed such that only a peripheral part of each of the large coins of diameters greater than the width L1 of the medium-coin passage section 110b runs onto the step 116a.

The ejecting passage 117a has a guide edge 118a for guiding a coin that has run onto the step 116a for movement in a substantially tangential direction, and an outlet 119a through which the coin guided by the guide edge 118a is ejected outside. Since all the coins engage the radial inner edge portion 110i-a, the medium coins and the small coins respectively having diameters smaller than the width L1 do not run onto the step 116a and move into the medium-coin passage section 10b.

A medium-coin sorting guide 115b is disposed radially outside the small-coin passage section 110c to guide only the medium coins selectively and to eject the medium coins in a substantially tangential direction. The medium-coin sorting guide 115b, similarly to the large-coin sorting guide 115a, has a step 116b and an ejecting passage 117b.

The step 116b is formed at a boundary between the medium-coin passage section 110b and the small-coin passage section 110c. The step 116b is formed such that only a peripheral part of each of the medium coins of diameters greater than the width L2 of the small-coin passage section 110c runs onto the step 116b. The step 116b is formed by an adjustable step plate S2′. The ejecting passage 117b, similarly to the ejecting passage 117a of the large-coin sorting guide 115a, has a guide edge 118b and an outlet 119b.

Since a downstream part of the medium-coin passage section 110b extends away from the center toward the outer circumference of the stationary disk 101, it is intended that the outer edges of all the coins moving therein should engage a radial inner edge portion 110i-b thereof. Thus, small coins of a diameter smaller than the width L2 move into the small-coin passage section 110c without running onto the step 116b.

The small-coin passage section 110c extends downstream toward the inner circumference and then toward the outer circumference of the stationary disk 101, and terminates in a small-coin sorting guide 115c having an outlet 119c.

Foreign matter sorting means 108 is arranged on the stationary disk 101. The foreign matter sorting means 108 has a foreign matter passage 180 branched off from the small-coin passage section 110c, and a stepped gate 182 formed at the junction of the small-coin passage section 110c and the foreign matter passage 180. The foreign matter sorting means 108 selectively ejects foreign matters, such as paper clips, thinner than the thinnest coin.

This coin sorting apparatus has the following problems. The radial inner edge portion 110i-a (110i-b), which is configured to engage the outer edges of all the coins, defines a shoulder formed in a height less than a thickness of a thinnest coin so as not to prevent the “lower coin” from returning, e.g. through the coin returning part 113, toward the inlet opening 1a. On the other hand, as shown in FIG. 15, there is a possibility that coins to be sorted include a deformed coin C′ bent such that a convex side thereof faces the lower surface 1b of the stationary disk 101. If the deformed coin C′ is fed into the coin passage 110 with its bending axis in a substantially tangential direction with respect to the coin passage 110, there is a possibility that the outer edge of the deformed coin C′ does not engage the radial inner edge portion 110i-a (110i-b). In this case, the coin sorting apparatus is likely to fail of an intended coin sorting operation and cause a miss-sorting and/or a hold-up of the coins therein.

In addition, considering a case of a coin jam between the stationary disk 101 and the rotary disk 2, it is advantageous if the sorting process can be continued by rotating the rotary disk 2 in reverse temporarily, and then continuing to rotating the rotary disk 2 forward in normal operation. However, in the above coin sorting apparatus, the guide edges 118a and 118b of the ejecting passages 117a and 117b include stepped portions 118a′ and 118b′. The stepped portions 118a′ and 118b′ define vertical walls formed transversely of coin-passing directions between the steps 116a and 116b and the ejecting passages 117a and 117b, respectively.

Therefore, once coins have passed into the ejecting passage 117a and 117b through the stepped portions 118a′ and 118b′, the coins cannot return to the upstream side with respect to the stepped portions 118a′ and 118b even if the rotary disk is reversely rotated. In this case, when the rotary disk 2 is rotated forward again, the coin sorting apparatus is likely to cause the miss-sorting and/or the hold-up of the coins therein and fail to resume a normal coin sorting operation.

### SUMMARY OF THE INVENTION

Accordingly, it is an object of the present invention to provide a coin sorting apparatus capable of ensuring an engagement of an outer edge of a deformed coin with a radial inner edge portion of a coin passage to always carry out a normal coin sorting operation.

Another object of the present invention is to provide a coin sorting apparatus capable of allowing coins that have passed into an ejecting passage through a stepped portion to return to an upstream side with respect to the stepped portion when the rotary disk is reversely rotated so as to resume a normal coin sorting operation when the rotary disk is rotated forward again.

According to the present invention, there is provided a coin sorting apparatus comprising: (a) a stationary member provided with a central coin-feed opening; and (b) a rotary disk supported for rotation and disposed under the stationary member contiguously with a lower surface of the stationary member, the coin sorting apparatus being constructed such that coins fed into the coin-feed opening of the stationary member slide along the lower surface of the stationary member as the rotary disk rotates, the stationary member being provided with a guide structure for selectively guiding coins sliding along the lower surface thereof, according to the diameters of the coins, the guide structure having (1) a coin passage formed in the lower surface of the stationary member and having a radial inner edge portion configured to engage outer edges of all the coins to be guided, the radial inner edge portion defining a shoulder formed in a height smaller than a thickness of a thinnest coin, and (2) a coin-sorting guide disposed radially outside the coin passage, the coin-sorting guide having (2a) a step formed such that a peripheral part of each of coins having diameters greater than a reference diameter run up onto the step with the outer edge thereof engaging the radial inner edge portion of the coin passage, and (2b) an ejecting passage for guiding the coin that has run up onto the step and ejecting the same coin outside the stationary member, the coin sorting apparatus being adapted to receive coins including a deformed coin bent such that a convex side thereof faces the lower surface of the stationary member, the coin passage having, at least in a section corresponding to the radial inner edge portion thereof, a recessed-profile configured to accommodate the convex side of the deformed coin to ensure an engagement of an outer edge of the deformed coin with the radial inner edge portion.

Thus, it is possible to ensure the engagement of the outer edge of the deformed coin with the radial inner edge portion of the coin passage having the recessed-profile. Accordingly, even if the coins to be sorted include the deformed coin, it is possible to always carry out a normal coin sorting operation.

In the coin sorting apparatus, the recessed-profile of the coin passage may include a stepped-profile configured to prop the peripheral part of each of the coins to be guided, on a radial outer side of the coin passage.

In the coin sorting apparatus, the recessed-profile of the coin passage preferably includes a plurality of stepped-profiles corresponding to a plurality of ranges of the diameters of the coins.

Thus, it is possible to form the recessed-profile having an optimum configuration for each of the ranges of the diameters of the coins.

In the coin sorting apparatus, the coin-sorting guide may further have a stepped portion formed transversely of a coin-passing direction between the step and the ejecting passage. In this case, the stepped portion preferably has a sloped configuration.

Thus, it is possible to allow coins that have passed into the ejecting passage through the stepped portion to smoothly return to the opposite side from the ejecting passage when the rotary disk is reversely rotated. Accordingly, it is possible to resume a normal coin sorting operation when the rotary disk is rotated forward again. In addition, it is possible to ensure a reliability of a batch stopping operation, i.e. an operation in which the coin sorting operation is suspended and resumed by stopping rotating the rotary disk and rotating the rotary disk forward as occasion demands.

In the coin sorting apparatus, preferably, the stationary member is further provided with a return guide configured to guide the coins to return the same toward the coin-feed opening when the rotary disk is rotated in a reverse direction.

Thus, when the rotary disk is reversely rotated, it is possible to reduce coins that are held-up between the stationary member and the rotary disk by means of the return guide. Accordingly, it is possible to more smoothly resume the normal coin sorting operation when the rotary disk is rotated forward again.

### BRIEF DESCRIPTION OF THE DRAWINGS

FIG. 1 is a plan view of a coin sorting apparatus in a preferred embodiment according to the present invention;

FIG. 2 is a longitudinal sectional view of disks of the coin sorting apparatus shown in FIG. 1;

FIG. 3 is a bottom view of a stationary disk of the coin sorting apparatus shown in FIG. 1;

FIG. 4 is a plan view of the disks for explaining the movement of coins in the coin sorting apparatus shown in FIG. 1;

FIG. 5 is a sectional view taken on line X-X in FIG. 4, in states where (a) a normal coin, (b) overlapping coins and (c) a deformed coin are moving in the coin passage, respectively;

FIG. 6 is an enlarged sectional view of a large-coin passage section corresponding to a part of FIG. 5(c);

FIG. 7 is a sectional view taken on line Y-Y in FIG. 4, in a state where a normal coin is moving in the coin passage;

FIG. 8 is a sectional view taken on line Z-Z in FIG. 4, in a state where a deformed coin is moving in the coin passage;

FIG. 9 is an enlarged view of a part of FIG. 4 corresponding to a section including a small-coin sorting guide;

FIG. 10 is a sectional view taken on line P-P in FIG. 9;

FIG. 11 is a view similar to FIG. 4, showing a state where the rotary disk is reversely rotated;

FIG. 12A is a sectional view showing a modification of the large-coin passage shown in FIG. 6;

FIG. 12B is a sectional view showing another modification of the large-coin passage shown in FIG. 6;

FIG. 13 is a longitudinal sectional view of a coin sorting apparatus of a related art;

FIG. 14 is a bottom view of a stationary disk of the coin sorting apparatus shown in FIG. 13;

FIG. 15 is a sectional view of disks of the coin sorting apparatus shown in FIG. 13, corresponding to a section taken on line X′-X′ in FIG. 14, in a state where a deformed coin is moving in the coin passage.

### DESCRIPTION OF THE PREFERRED EMBODIMENTS

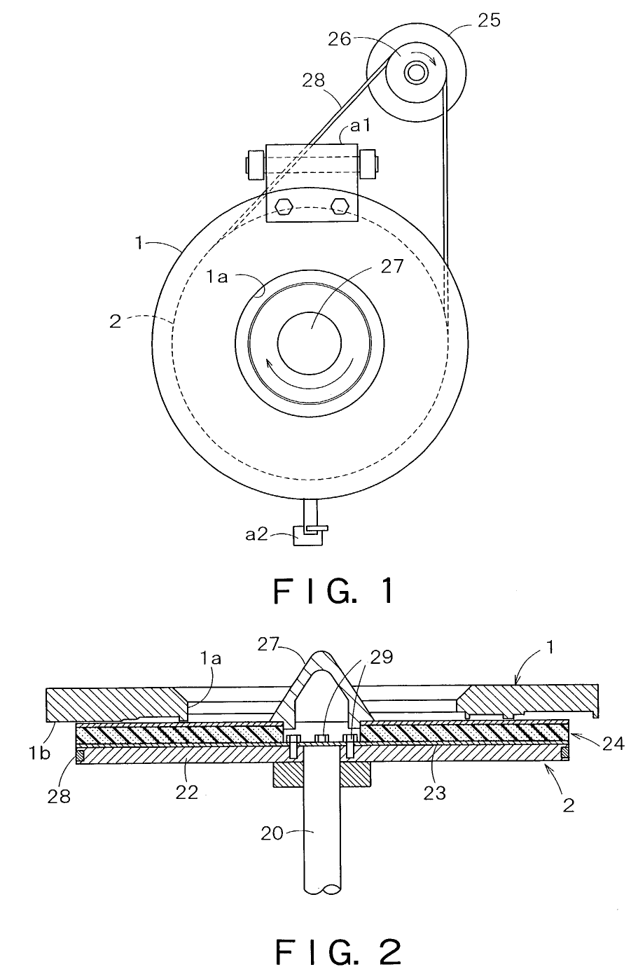

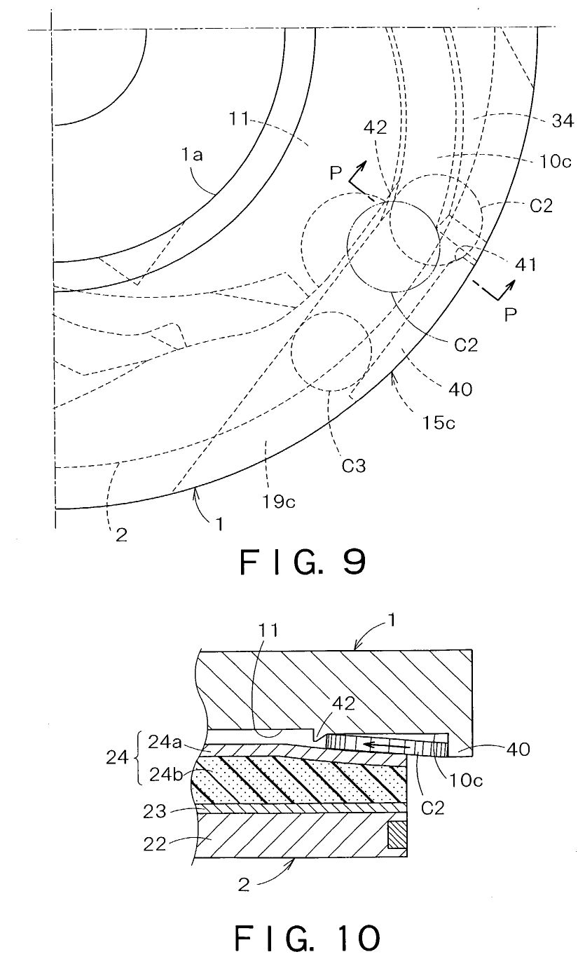

Preferred embodiments of the present invention will be described with reference to FIGS. 1 to 11 of the accompanying drawings.

[General Construction]

Referring to FIGS. 1 and 2, a coin sorting apparatus of the preferred embodiment comprises a stationary disk (stationary member) 1 and a rotary disk 2 disposed under the stationary disk 1 contiguously with a lower surface thereof. The stationary disk 1 and the rotary disk 2 are joined by a hinge a1 (FIG. 1) so that the stationary disk 1 can be turned on the hinge a1 relative to the rotary disk 2. A locking device a2 (FIG. 1) connected to a part diametrically opposite to the hinge a1 of the stationary disk 1 locks the stationary disk 1 in place over the rotary disk 2.

An inlet opening (coin-feed opening) 1a is formed in a central part of the stationary disk 1. The coin sorting apparatus is formed such that a coin fed through the inlet opening 1a of the stationary disk 1 slides along the lower surface 1b (FIG. 2) of the stationary disk 1 as the rotary disk 2 rotates. A guide structure (described later) is formed in the stationary disk 1 for selectively guiding coins sliding along the lower surface 1b of the stationary disk 1, according to the diameters of the coins.

[Construction of Rotary Disk]

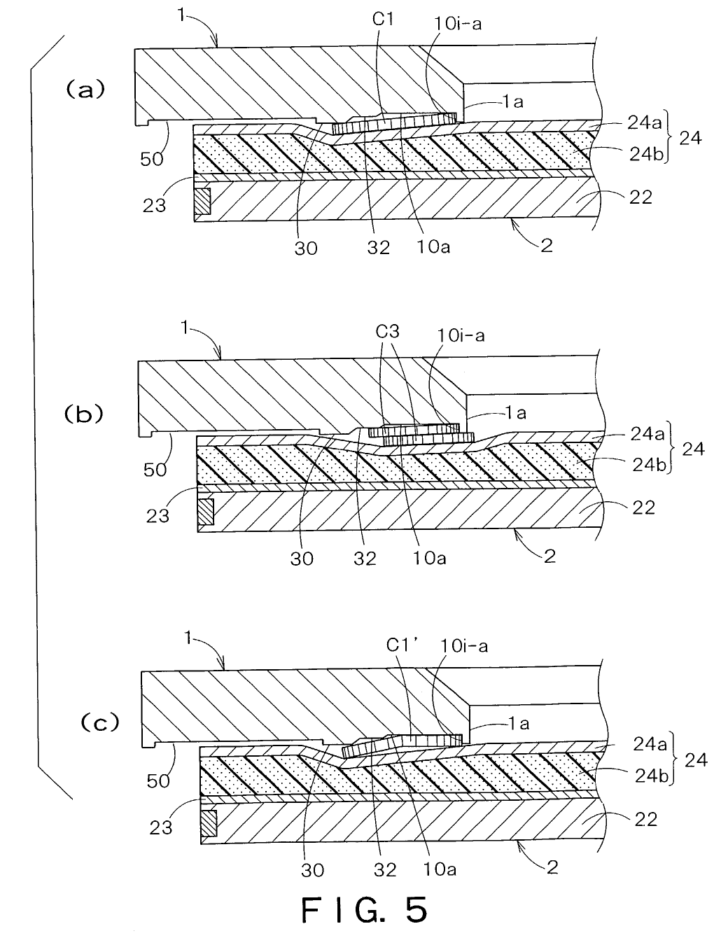

The rotary disk 2 comprises a disk body 22 supported for rotation on a shaft 20, a disk-shaped resilient member 24 attached to an upper surface of the disk body 22. As shown in FIG. 5, the resilient member 24 has a thin urethane rubber layer 24a and a porous resilient layer 24b underlying the urethane rubber layer 24a. Preferably, the porous resilient layer 24b is formed of rubber sponge (foam rubber) having a comparatively high impact resilience. A circular metal plate 23 is attached to the lower surface of the resilient member 24. The metal plate 23 is fastened to the disk body 22 with screws 29 to attach the resilient member 24 detachably to the disk body 22.

The resilient member 24 attached to the disk body 22 holds coins together with the stationary disk 1 and moves the coins as the rotary disk 2 rotates. In addition, the resilient member 24 absorbs the variation of the thickness of the gap between the resilient member 24 and the stationary disk 1, and differences in thickness between coins of different denominations (FIGS. 5, 7 and 8).

As shown in FIG. 1, the rotary disk 2 is driven for rotation by a motor 25 through a pulley 26 attached to the output shaft of the motor 25 and a drive belt 28 extended between the pulley 26 and the disk body 22 (FIG. 5) of the rotary disk 2. A conical member 27 is disposed on a central part of the rotary disk 2 to prevent coins from staying on the central part of the rotary disk 2.

[Construction of Stationary Disk]

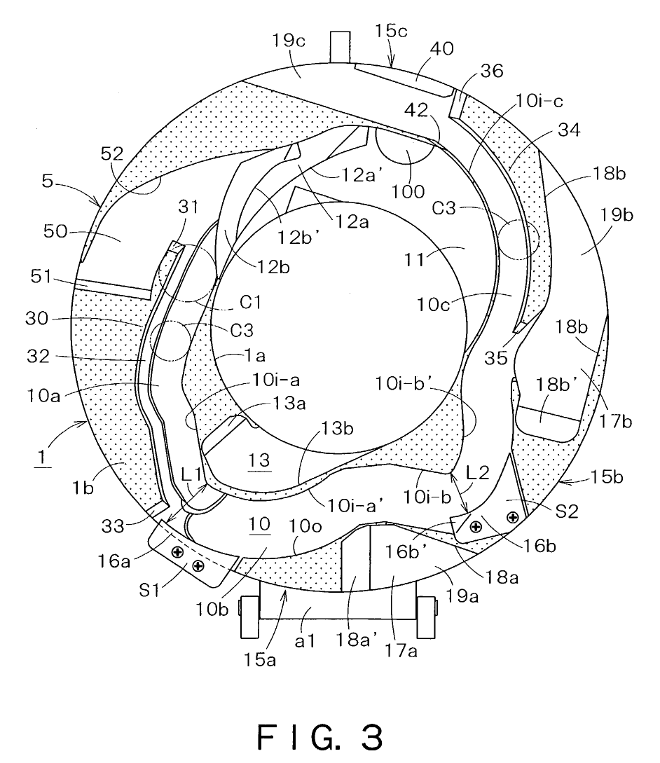

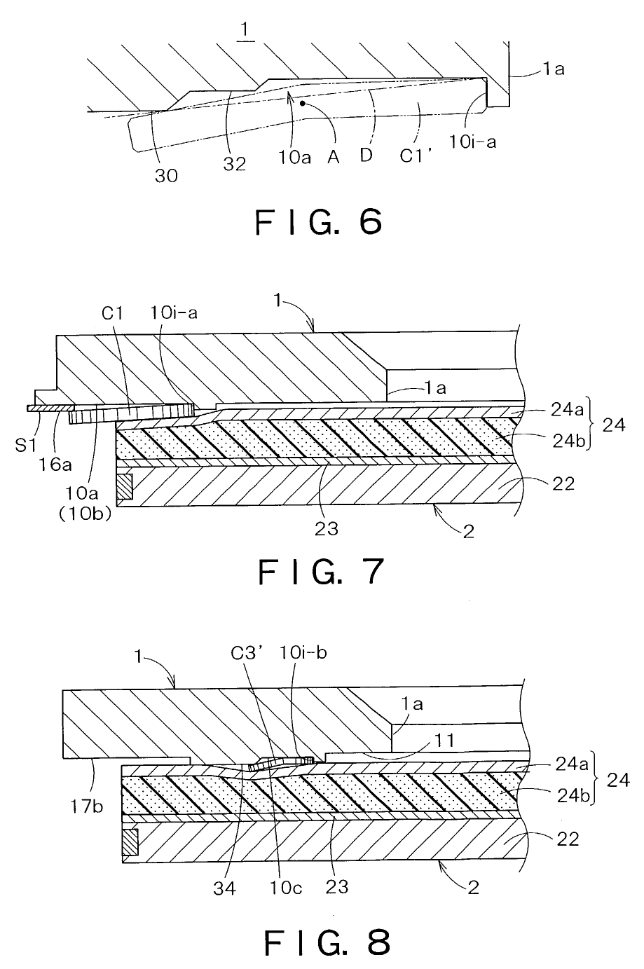

The specific construction of the stationary disk 1, especially the guide structure formed on the lower surface 1b thereof, will be described with reference to FIGS. 3 to 11. In the following descriptions, reference symbols C1, C2 and C3 denote normal (flat) coins. On the other hand, reference symbols C1′, C2 ′ and C3′ denote deformed coins bent such that a convex side thereof faces the lower surface 1b of the stationary disk 1, especially the deformed coins fed into a coin passage 10 (described later) with bending axes A (FIG. 6) thereof in a substantially tangential direction with respect to the coin passage 10 as shown in FIG. 6. The bending axis A of each deformed coin C1′, C2′ or C3′ extends in the substantially diametral direction thereof.

As shown in FIG. 3, the guide structure comprises a coin passage 10 formed concavely in the lower surface 1b of the stationary disk 1. The coin passage 10 extends counterclockwise as viewed in FIG. 3 in a meandering spiral from the inlet opening 1a toward the periphery of the stationary disk 1. The coin passage 10 has, arranged from the inlet opening 1a toward the periphery of the stationary disk 1, a large-coin passage section 10a, a medium-coin passage section 10b and a small-coin passage section 10c. The large-coin passage section 10a is configured to permit the passage of large, medium and small coins C1, C2 and C3. The medium-coin passage section 10b has a width L1 that permits the passage of only medium and small coins C2 and C3. The small-coin passage section 10c has a width L2 that permits the passage of only small coins C3 in an upstream section thereof.

The large-coin passage section 10a has a coin entrance 11 facing the inlet opening 1a, and stairs 12a and 12b formed at an interval on the downstream side with respect to the coin entrance 11. The coin entrance 11 is formed such that the thickness of a gap between the coin entrance 11 and the resilient member 24 of the rotary disk 2 (FIG. 2) is greater than that of the thickest coins. Thus, all the coins fed into the inlet opening 1a can be moved into the coin entrance 11 by centrifugal force as the rotary disk 2 rotates.

There is a possibility that a pair of overlapping coins are moved into the coin entrance 11. The overlapping coins include an “upper coin” that is contiguous with the stationary disk 1 and a “lower coin” that is contiguous with the rotary disk 2 (see FIG. 5(b)). Thus, the coin entrance 11 is provided with a semicircular protrusion 100 in a radial outer side thereof. The protrusion 100 pushes the “upper coin” back toward the inlet opening 1a.

The stairs 12a and 12b are formed to reduce the thickness of the gap between the resilient member 24 of the rotary disk 2 (FIG. 2) and the large-coin passage section 10a stepwise toward the downstream side thereof. By virtue of the stairs 12a and 12b, overlapping coins are separated from each other to ensure that coins do not overlap each other and move in a single file in the coin passage 10. FIG. 5(a) shows the state where large coins C1 are moving in a single file in the large-coin passage section 10a.

As shown in FIG. 3, a coin returning part 13 is formed contiguously with the inlet opening 1a in a region corresponding to the boundary between the large-coin passage section 10a and the medium-coin passage section 10b. The coin returning part 13 deals with overlapping coins passed stairs 12a and 12b without being separated. The upstream and the downstream side of the coin returning part 13 are limited by an sloped step portion 13a and a vertical guiding step portion 13b, respectively.

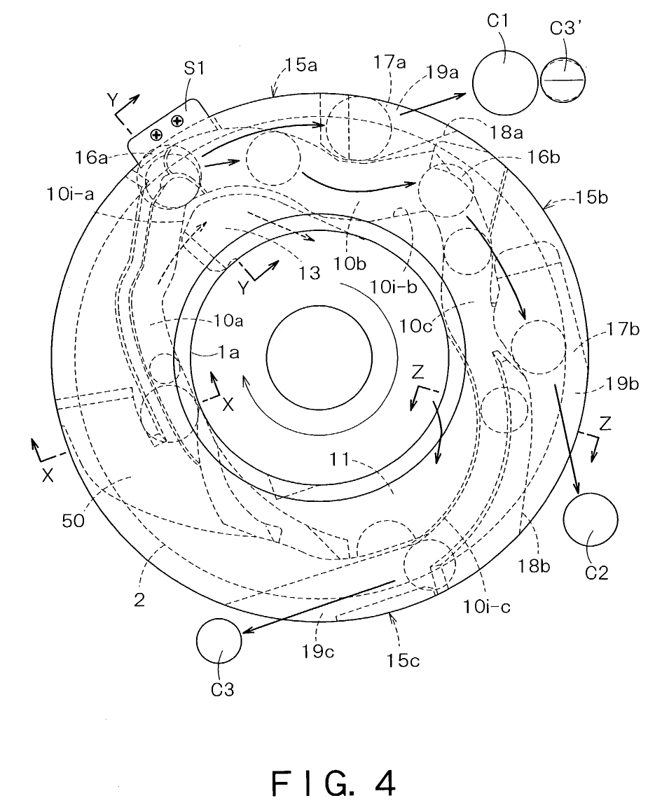

Since the large-coin passage section 10a extends spirally away from the center toward the circumference of the stationary disk 1, it is intended that the outer edges of all the coins moving therein should engage a radial inner edge portion 10i-a thereof (see FIG. 4). The radial inner edge portion 10i-a defines a shoulder formed in a height smaller than a thickness of a thinnest coin so as not to prevent the “lower coin” from returning toward the inlet opening 1a (see FIG. 5). The coin returning part 13 is configured to receive the “lower coin” passing over the edge portion 10i-a through the step portion 13a and return the same coin toward the inlet opening 1a by means of the guiding step portion 13b.

As shown in FIGS. 3, 5 and 6, the large-coin passage section 10a has, at least in a section corresponding to the inner edge portion 10i-a, a recessed-profile configured to accommodate the convex sides of the deformed coins C1′, C2′ and C3′ to ensure an engagement of the outer edges of the deformed coins with the edge portion 10i-a. FIG. 6 shows that the large-coin passage section 10a is recessed more deeply than an imaginary reference plane D for the normal coins so as to have the recessed-profile.

The recessed-profile of the large-coin passage section 10a includes a stepped-profile configured to prop the peripheral part of each of the coins to be guided, on a radial outer side of the passage section 10a. The stepped-profile of the passage section 10a includes an outer circumferential step 30 for the large coins and an outer circumferential step 32 for the medium and small coins to form two-stepped-profile corresponding to two ranges of the diameters of the coins. Stepped portions 31 and 33 (FIG. 3) are formed at an upstream end and a downstream end of the outer circumferential step 30, respectively. The stepped portions 31 and 33 have sloped configurations for allowing the coins to pass easily.

Referring to FIGS. 3 and 4, a large-coin sorting guide 15a is disposed radially outside the medium-coin passage section 10b to guide only the large coins C1 selectively and to eject the large coins C1 in a substantially tangential direction. The large-coin sorting guide 15a has a step 16a and an ejecting passage 17a. The step 16a is formed at a boundary between the large-coin passage section 10a and the medium-coin passage section 10b. The step 16a is formed such that only a peripheral part of each of the large coins C1 (including the deformed coins C1′) of diameters greater than the width L1 of the medium-coin passage section 10b runs onto the step 16a (see FIGS. 4 and 7).

The ejecting passage 17a has a guide edge 18a for guiding a coin that has run onto the step 16a for movement in a substantially tangential direction, and an outlet 19a through which the coin guided by the guide edge 18a is ejected outside. The sorting guide 15a further has a stepped portion 18a′ formed transversely of a coin-passing direction between the step 16a and the ejecting passage 17a. The stepped portion 18a′ has a sloped configuration for allowing the coins to pass easily.

Since all the coins engage the radial inner edge portion 10i-a, the medium coins C2 and the small coins C3 respectively having diameters smaller than the width L1 do not run onto the step 16a and move into the medium-coin passage section 10b.

On the other hand, an outer edge of each of the medium and small deformed coins C2′ and C3′, is difficult to engage a radial outer edge 10o of the coin passage 10 between the step 16a and the ejecting passage 17a. Accordingly, there is a strong possibility that the deformed coins C2′ and C3′ pass over the edge 10o to enter the ejecting passage 17a. Thus, almost all the deformed coins C2 ′ and C3′ are ejected outside from the outlet 19a of the ejecting passage 17a, in the same way as the large deformed coin C1′.

A medium-coin sorting guide 15b is disposed radially outside the small-coin passage section 10c to guide only the medium coins C2 selectively and to eject the medium coins C2 in a substantially tangential direction. The medium-coin sorting guide 15b, similarly to the large-coin sorting guide 15a, has a step 16b and an ejecting passage 17b.

The step 16b is formed at a boundary between the medium-coin passage section 10b and the small-coin passage section 10c. The step 16b is formed such that only a peripheral part of each of the medium coins C2 of diameters greater than the width L2 of the small-coin passage section 10c runs onto the step 16b. A ramp 16b′ (FIG. 3) is formed on the upstream side of the step 16b to facilitate coins running onto the step 16b.

The ejecting passage 17b, similarly to the ejecting passage 17a of the large-coin sorting guide 15a, has a guide edge 18b and an outlet 19b. The sorting guide 15b further has a stepped portion 18a′ formed transversely of a coin-passing direction between the step 16b and the ejecting passage 17b. The stepped portion 18b′ also has a sloped configuration for allowing the coins to pass easily.

Since a downstream part of the medium-coin passage section 10b extends away from the center toward the outer circumference of the stationary disk 1, it is intended that the outer edges of all the coins moving therein should engage a radial inner edge portion 10i-b thereof (see FIG. 4). Thus, small coins C3 of a diameter smaller than the width L2 move into the small-coin passage section 10c without running onto the step 16b.

The small-coin passage section 10c extends downstream toward the inner circumference and then toward the outer circumference of the stationary disk 1, and terminates in a small-coin sorting guide 15c having an outlet 19c. The small-coin sorting guide 15c is configured to guide only the small coins C3 selectively and to eject the small coins C3 in a substantially tangential direction. Since a downstream part of the small-coin passage section 10c also extends away from the center toward the outer circumference of the stationary disk 1, it is intended that the outer edges of all the coins moving therein should engage a radial inner edge portion 10i-c thereof (see FIG. 4). The radial inner edge portion 10i-c also defines a shoulder formed in a height smaller than the thickness of the thinnest coin so as not to prevent the “lower coin” from returning toward the inlet opening 1a (coin entrance 11).

As described above, almost all the deformed coins C2 ′ and C3′ are ejected outside from the outlet 19a for the large coins. There is a possibility that some of the deformed coins C2′ and C3′ pass though the medium-coin passage section 10b and enter the small-coin passage section 10c.

Thus, as shown in FIGS. 3 and 8, the small-coin passage section 10c also has, at least in a section corresponding to the inner edge portion 10i-c, a recessed-profile configured to accommodate the convex sides of the deformed coins C2′ and C3′ to ensure an engagement of the outer edges of the deformed coins with the edge portion 10i-c. The recessed-profile of the small-coin passage section 10c includes a stepped-profile configured to prop the peripheral part of each of the coins to be guided, on a radial outer side of the passage section 10c. The stepped-profile of the passage section 10c includes an outer circumferential step 34 for the medium and small coins. Stepped portions 35 and 36 (FIG. 3) are formed at an upstream end and a downstream end of the outer circumferential step 34, respectively. The stepped portions 31, 33 have sloped configurations for allowing the coins to pass easily.

Referring to FIGS. 3, 9 and 10, in a downstream part of the small-coin passage section 10c, a protrusion 40 is formed on a radial outer side thereof before the outlet 19c. The protrusion 40 has a bevel 41 for returning the medium coins. A slope portion 42 is formed in an opposite side of the small-coin passage section 10c to the bevel 41 of the protrusion 40.

Even if the medium coin C2 (including the deformed medium coin C2′) enters the small-coin passage section 10c for some reason, it is possible to return the medium coin C2 toward the inlet opening 1a (coin entrance 11) by means of the bevel 41 of the protrusion 40 and the slope portion 42. That is to say, the medium coin C2 is pushed by the bevel 41 toward the radial inner side of the passage section 10c so that the medium coin C2 runs onto the slope portion 42. Then, the medium coin C2 is returned toward the inlet opening 1a while passing over the radial inner side of the passage section 10c, as the rotary disk 2 rotates forward, i.e. in normal direction.

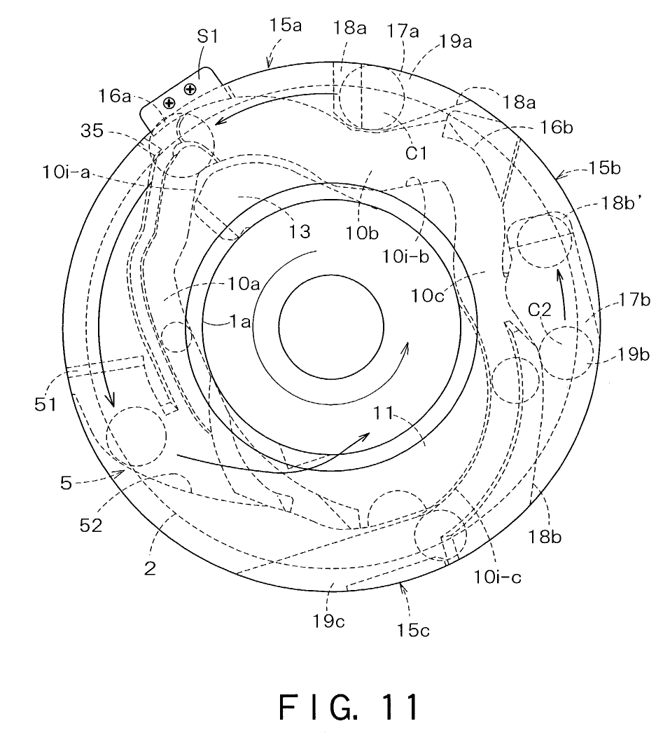

Referring to FIGS. 3 and 11, in a upstream part of the large-coin passage section 10a (when rotary disk 2 rotates forward), a return guide 5 having a return passage 50 and a guiding edge 52 is formed on a radial outer side thereof. The return guide 5 is configured to guide the coins that have moved to the radial outer side of the stationary disk 1 to return the same coins toward the inlet opening 1a (coin entrance 1) when the rotary disk 2 is rotated in the reverse direction, as shown in FIG. 11. A stepped portion 51 is formed at an entrance of return passage 50, i.e. an upstream end of the return passage 50 when the rotary disk 2 is reversely rotated. The stepped portion 51 has a sloped configuration for allowing the coins to pass easily.

As shown in FIG. 3, the coin passage 10 extends downstream from the steps 16a and 16b to approach the center of the stationary disk 1, respectively. That is to say, two sections of the coin passage 10 downstream from the steps 16a and 16b have radial inner edge portions 10i-a′ and 10i-b′ approaching the center of the stationary disk 1, respectively. Therefore, when the rotary disk 2 is reversely rotated, the inner edge portions 10i-a′ and 10i-b′ urge coins radial outward to ensure the engagement of the coins with the edge portions 10i-a′ and 10i-b′. Thus, even if the return guide 5 fails to return some coins toward the inlet opening 1a when the rotary disk 2 is reversely rotated, it is intended that the outer edges of those coins should engage the inner edge portions 10i-a and 10i-b opposite the steps 16a and 16b when the rotary disk 2 is rotated forward again.

As sown in FIG. 3, in this preferred embodiment, the steps 16a and 16b are formed by step plates S1 and S2 fastened to the stationary disk 1 with screws. The step plates S1 and S2 may be horizontally adjustable on the stationary disk 1 with respect to the width of the coin passage 10. In this case, the widths L1 and L2 of the coin passage 10 corresponding to the steps 16a and 16b are adjusted so that the widths L1 and L2 conform to the diameter of coins to be sorted. The reliability and smoothness of a coin sorting process can be enhanced by finely adjusting the widths L1 and L2 of the coin passage 10. The step plates S1 and S2 may be formed of an abrasion-resistant material separately from the stationary disk 1 and may be subjected to a hardening process.

[Functions and Effects]

The functions and effects of this embodiment thus constructed will be described. Some of the functions and effects will be omitted or simplified, if those functions and effects are apparent from the foregoing descriptions.

According to this embodiment, it is possible to ensure the engagement of the outer edge of the deformed coins C1′, C2 ′ and C3′ with the radial inner edge portions 10i-a and 10i-c of the passage sections 10a and 10c each having the recessed-profile. Accordingly, even if the coins to be sorted include the deformed coins C1′, C2 ′ and C3′, it is possible to always carry out a normal coin sorting operation.

In addition, the stepped-profile of the passage section 10a includes two outer circumferential steps 30 and 32 corresponding to two ranges of the diameters of the coins, i.e. the large coins, and the medium and small coins. Thus, it is possible to form the recessed-profile of the passage section 10a having an optimum configuration for each of the ranges of the diameters of the coins.

In this embodiment, almost all the deformed coins C1′, C2 ′ and C3′ are ejected outside from the outlet 19a for large coins. Thus, it is possible to sort the deformed coins C1′, C2′ and C3′ from the medium and small normal coins C2 and C3. Accordingly, it is advantageous that the large coins C1 are treated as reject coins, because the deformed coins C1′, C2′ and C3′ can be treated as the reject coins together with the large coins C1.

By the way, there is a possibility that few medium and small deformed coins C2′ and C3′ are sorted out together with the medium and small normal coins C2 and C3, respectively. There is also a possibility that the medium and small deformed coins C2′ and C3′ happen to be fed into the coin passage 10 with their bending axes in substantially radial direction with respect to the coin passage 10. In addition, there may be some medium and small coins bent such that convex sides thereof face the upper surface of the rotary disk 2, as opposed to the deformed coins C2′ and C3′. There is a strong possibility that those medium and small coins are sorted out together with the medium and small normal coins C2 and C3, respectively. Thus, those coins may be separately rejected by using an optical discriminator and so forth, after they are sorted by the sorting apparatus of this embodiment, e.g. before the sorted coins are re-sorted by denominations.

The stepped portions 18a′ and 18b′ (FIG. 3) between the steps 16a and 16b and the ejecting passages 17a and 17b have sloped configurations for allowing the coins to pass easily, respectively. Thus, it is possible to allow coins that have passed into the ejecting passages 17a and 17b through the stepped portions 18a′ and 18b′ to smoothly return to the opposite side from the ejecting passages 17a and 17b when the rotary disk 2 is reversely rotated. In the passage sections 10a and 10c, the stepped portions 33 and 36 (FIG. 3) of the outer circumferential steps 30 and 34 also have sloped configurations for allowing the coins to pass easily, respectively. Accordingly, it is possible to resume a normal coin sorting operation when the rotary disk 2 is rotated forward again. In addition, it is possible to ensure a reliability of a batch stopping operation, i.e. an operation in which the coin sorting operation is suspended and resumed by stopping the rotary disk 2 and rotating the rotary disk 2 forward as occasion demands.

Furthermore, when the rotary disk 2 is reversely rotated, it is possible to reduce coins that are held-up between the stationary disk 1 and the rotary disk 2 by means of the return guide 5. Accordingly, it is possible to more smoothly resume the normal coin sorting operation when the rotary disk 2 is rotated forward again.

[Modifications]

Some modifications of this embodiment will be described.

In the present invention, the recessed-profile of the coin passage is not limited to that described above. The recessed-profile may be any kind of profile configured to accommodate the convex side of the deformed coin to ensure the engagement of the outer edge of the deformed coin with the radial inner edge portions.

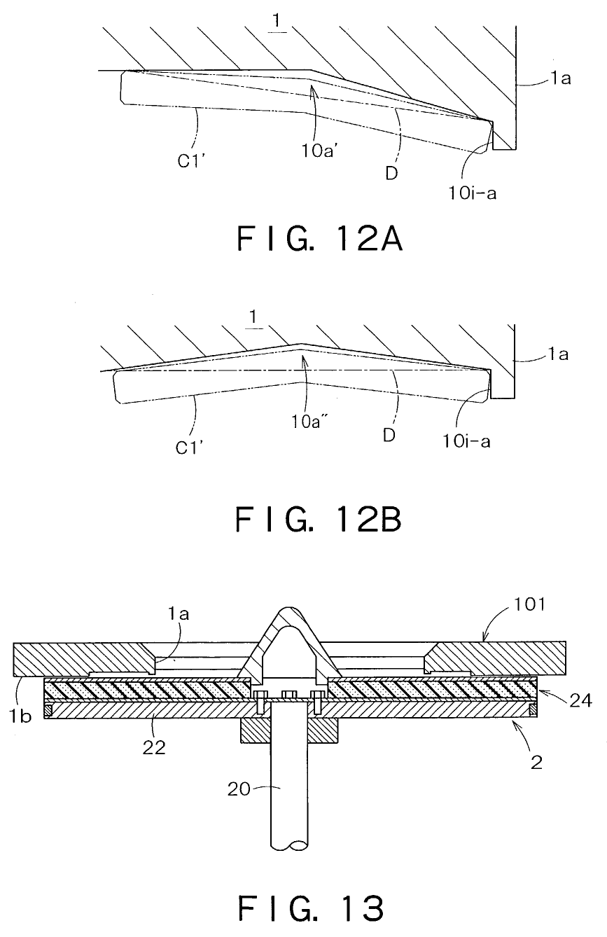

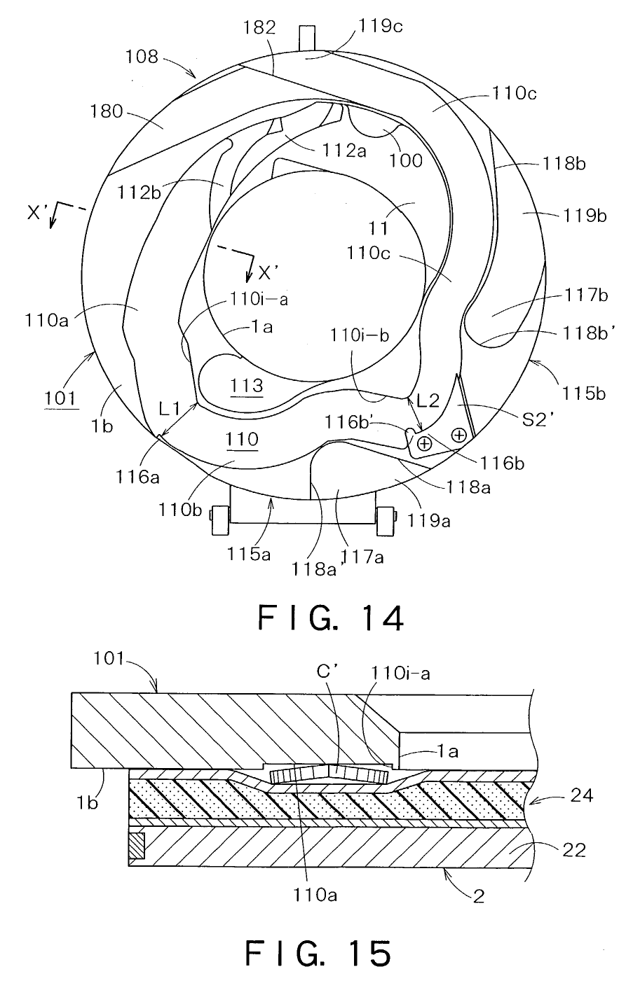

For example, in place of the recessed-profile of the large-coin passage section 10a shown in FIG. 6, modified recessed-profiles are shown in FIGS. 12A and 12B. In the passage section 10a shown in FIG. 6, the imaginary reference plane D for the normal coins inclines downwardly from the radial inner side toward the outer side of the passage section 10a (the example of the reference plane D for the large normal coin C1 is shown in FIG. 6). On the other hand, FIG. 12A shows a passage section 10a′ in which the reference plane D inclines oppositely, i.e. upwardly from the radial inner side toward the outer side thereof. FIG. 12B shows a passage section 10a″ in which the reference plane D is substantially horizontal. Incidentally, for clearer comparison of the profiles, each of the passage sections 10a′ and 10a″ (FIGS. 12A and 12B) has a more simple recessed-profile than the stepped-profile shown in FIG. 6. That is to say, each of the recessed-profiles of the passage sections 10a′ and 10a″ is the simple profile merely corresponding to the convex side of the deformed coin C1′.

What is claimed is:

1. A coin sorting apparatus comprising:
(a) a stationary member provided with a central coin-feed opening; and
(b) a rotary disk supported for rotation and disposed under the stationary member contiguously with a lower surface of the stationary member,
the coin sorting apparatus being constructed such that coins fed into the coin-feed opening of the stationary member slide along the lower surface of the stationary member as the rotary disk rotates,
the stationary member being provided with a guide structure for selectively guiding coins sliding along the lower surface thereof, according to the diameters of the coins,
the guide structure having
(1) a coin passage formed in the lower surface of the stationary member and having a radial inner edge portion configured to engage outer edges of all the coins to be guided, the radial inner edge portion defining a shoulder formed in a height smaller than a thickness of a thinnest coin, and
(2) a coin-sorting guide disposed radially outside the coin passage,
the coin-sorting guide having
(2a) a step formed such that a peripheral part of each of coins having diameters greater than a reference diameter run up onto the step with the outer edge thereof engaging the radial inner edge portion of the coin passage, and
(2b) an ejecting passage for guiding the coin that has run up onto the step and ejecting the same coin outside the stationary member,
the coin sorting apparatus being adapted to receive coins including a deformed coin bent such that a convex side thereof faces the lower surface of the stationary member,
the coin passage having, at least in a section corresponding to the radial inner edge portion thereof, a recessed-profile configured to accommodate the convex side of the deformed coin to ensure an engagement of an outer edge of the deformed coin with the radial inner edge portion.

2. The coin sorting apparatus according to claim 1, wherein the recessed-profile of the coin passage includes a stepped-profile configured to prop the peripheral part of each of the coins to be guided, on a radial outer side of the coin passage.

3. The coin sorting apparatus according to claim 2, wherein the recessed-profile of the coin passage includes a plurality of stepped-profiles corresponding to a plurality of ranges of the diameters of the coins.

4. The coin sorting apparatus according to claim 1, wherein the coin-sorting guide further having a stepped portion formed transversely of a coin-passing direction between the step and the ejecting passage, the stepped portion having a sloped configuration.

5. The coin sorting apparatus according to claim 4, wherein the stationary member being further provided with a return guide configured to guide the coins to return the same toward the coin-feed opening when the rotary disk is rotated in a reverse direction.
